(19) United States
(12) Patent Application Publication
(10) Pub. No.: US 2026/0302639 A1
(43) Pub. Date: Oct. 1, 2026

(54) RADIO WAVE CONTROL PLATE CASING

(71) Applicant: KYOCERA Corporation, Kyoto-shi, Kyoto (JP)

(72) Inventors: Takuya HOTAKA, Yokohama-shi, Kanagawa (JP); Junpei YAMAZAWA, Yokohama-shi, Kanagawa (JP)

(21) Appl. No.: 19/489,422

(22) PCT Filed: May 8, 2024
(86) PCT No.: PCT/JP2024/017137

§ 371 Date: Dec. 2, 2025

(30) Foreign Application Priority Data
Jun. 5, 2023 (JP) 2023-092421

(51) Int. Cl. H01Q 15/23; H01Q 1/12

(52) U.S. Cl. CPC H01Q 15/23; H01Q 1/12

(57) ABSTRACT

To provide a radio wave control plate casing that has no influence on reflected waves or refracted waves of a radio wave control plate. The radio wave control plate casing according to the present disclosure is a radio wave control plate casing that accommodates the radio wave control plate for reflecting or refracting radio waves, and the radio wave control plate casing includes no structure constituting the radio wave control plate casing existing within a maximum angle θ of radio wave traveling direction control of the radio wave control plate.

### TECHNICAL FIELD

The present disclosure relates to a radio wave control plate casing.

### BACKGROUND OF INVENTION

Anchoring methods of reflective portions such as metal reflective plates used as passive relay apparatuses and parabolic antennas have a shape in which an anchoring portion is provided on a rear side of the reflective portion. In recent years, as one of the means for eliminating coverage holes, metasurface refractive plates have been proposed, and these also include the same anchoring method.

For example, the following Patent Document 1 discloses a radio wave scattering apparatus including a plurality of radio wave scattering portions, which can widen a scattering beam width compared with a case in which phases are not corrected among the plurality of radio wave scattering portions.

### CITATION LIST

### Patent Literature

Patent Document 1: JP 2022-189533 A

### SUMMARY

However, since the metasurface refractive plate refracts radio waves while transmitting the radio waves to the rear side of the plate, a problem occurs in that characteristics of the refracted radio waves deteriorate when an anchoring portion is provided on the rear side of the radio wave control plate as in the metal reflective plate.

The present disclosure has been made in view of the above problem, and an object of the present disclosure is to provide a radio wave control plate casing that has less influence on reflected waves or refracted waves of the radio wave control plate.

To solve the above-described problem and achieve the object, a radio wave control plate casing according to the present disclosure is a radio wave control plate casing that accommodates a radio wave control plate reflecting or refracting radio waves, and the radio wave control plate casing includes no structure constituting the radio wave control plate casing within a maximum angle θ of radio wave traveling direction control of the radio wave control plate.

According to the present disclosure, a radio wave control plate casing, which has less influence on reflected waves or refracted waves of the radio wave control plate, can be provided.

### BRIEF DESCRIPTION OF THE DRAWINGS

FIG. 1 is a diagram illustrating a configuration example of a radio wave reflection apparatus according to the present disclosure.

FIG. 2 is a front view of a holding portion of a radio wave control plate casing according to the present disclosure.

FIG. 3 is a cross-sectional view taken along line A-A of the holding portion of the radio wave control plate casing according to the present disclosure.

FIG. 4 is a front view of an anchoring portion of the radio wave control plate casing according to the present disclosure.

FIG. 5 is a diagram illustrating a model of the anchoring portion of the radio wave control plate casing according to the present disclosure.

FIG. 6 is a diagram illustrating a diameter of the anchoring portion of the radio wave control plate casing according to the present disclosure.

FIG. 7 is a diagram illustrating a position of a B-B cross section of the radio wave control plate casing according to the present disclosure.

FIG. 8 is a cross-sectional view taken along line B-B of the radio wave control plate casing according to the present disclosure.

FIG. 9 is a front view of Pattern A of the anchoring portion of the radio wave control plate casing according to the present disclosure.

FIG. 10 is a cross-sectional view taken along line C-C of Pattern A of the anchoring portion of the radio wave control plate casing according to the present disclosure.

FIG. 11 is a front view of Pattern B of the anchoring portion of the radio wave control plate casing according to the present disclosure.

FIG. 12 is a cross-sectional view taken along line D-D of Pattern B of the anchoring portion of the radio wave control plate casing according to the present disclosure.

FIG. 13 is a detailed view of a cross-sectional view taken along line D-D of Pattern B of the anchoring portion of the radio wave control plate casing according to the present disclosure.

### DESCRIPTION OF EMBODIMENTS

Embodiments of the present disclosure will be described in detail with reference to the drawings. Note that the embodiments described below are not limited to the present disclosure.

### Configuration of Radio Wave Reflection Apparatus

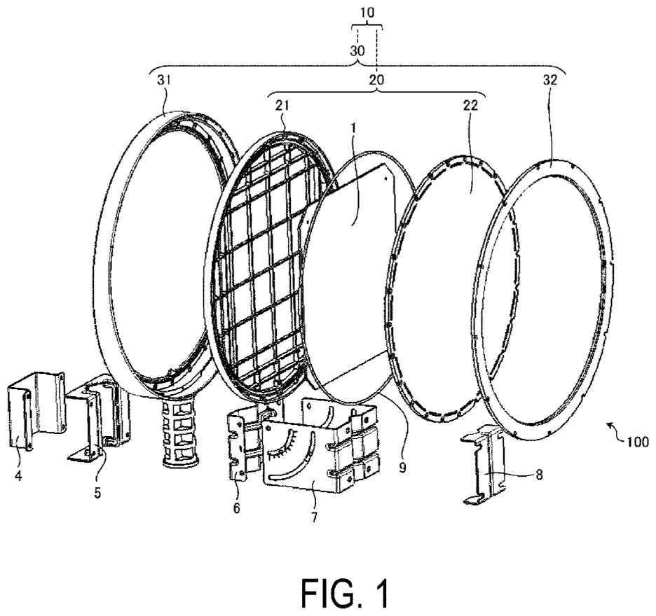

First, a configuration of a radio wave reflection apparatus 100 according to the present disclosure will be described with reference to FIG. 1. FIG. 1 is a diagram illustrating a configuration example of the radio wave reflection apparatus according to the present disclosure. As illustrated in FIG. 1, the radio wave reflection apparatus 100 according to the present disclosure includes a radio wave control plate 1, a casing 10 (a casing 20 and a casing 30), metal plates 4, 5, 6, 7, and 8, and a packing 9.

The radio wave control plate 1 is a plate that controls a traveling direction of radio waves by reflection or refraction. The radio wave control plate 1 may be, for example, a metasurface refractive plate that refracts radio waves at an angle of refraction different from an angle of incidence. The radio wave control plate 1 includes a plurality of phase modulation elements disposed on a dielectric substrate.

The casing 10 includes the casing 20 and the casing 30. That is, the casing 10 has a structure in which the casing 20 is accommodated inside the casing 30.

The casing 20 includes a casing member 21 and a casing member 22. The casing 20 sandwiches the radio wave control plate 1 with the casing member 21 and the casing member 22, and accommodates the radio wave control plate 1 inside the casing 20. The casing member 21 includes a hole for adjusting the atmospheric pressure, since when the inside of the casing is sealed with a packing, a change in atmospheric pressure occurs inside the casing due to a temperature change, and deformation of the casing occurs. The casing member 21 and the casing member 22 are made of a material having weather resistance or a material subjected to surface treatment.

The casing 30 includes a casing member (holding portion) 31 and a casing member (holding portion) 32. The casing 30 is made of a material having weather resistance or a material subjected to surface treatment in consideration of being installed outdoors. Note that the casing member 31 is anchored by the metal plate 5 and the metal plate 6.

The metal plates 4, 5, 6, 7, and 8 are members anchoring and supporting the casing at an installation place. The metal plates 4, 5, 6, 7, and 8 are made of a material having weather resistance or a material subjected to surface treatment. A structure (a balcony handrail, a pole, or the like of an apartment) to be installed is sandwiched between the metal plates 7 and 8, and the structure is anchored by fastening. Note that the metal plate 4 is provided from the viewpoint of design.

The packing 9 is provided between the casing member 21 and the casing member 22, and makes the inside of the casing 20 airtight. The packing 9 may be, for example, a rubber packing.

### Radio Wave Control Plate Casing

### Holding Portion

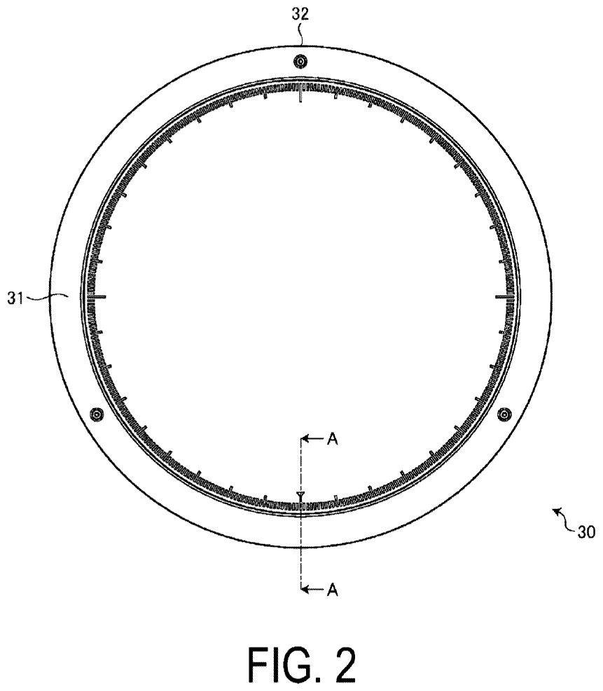

The casing members (holding portions) 31 and 32 of the radio wave control plate casing will be described with reference to FIG. 2. FIG. 2 is a front view of the holding portion of the radio wave control plate casing according to the present disclosure. As illustrated in FIG. 2, the casing members (holding portions) 31 and 32 of the radio wave control plate casing 30 according to the present disclosure are formed by combining the casing member (holding portion) 31 and casing member (holding portion) 32.

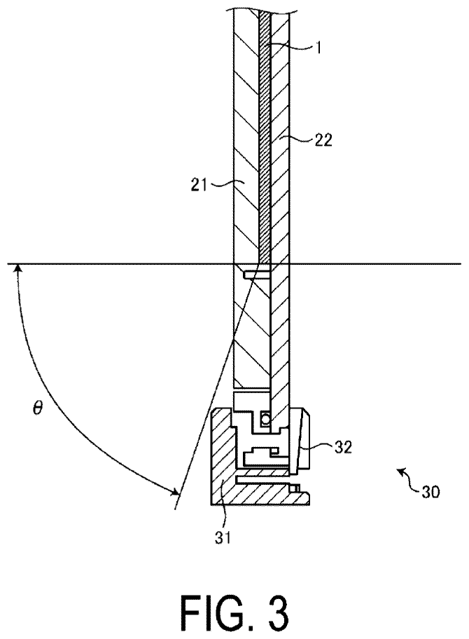

The structure of the radio wave control plate casing 30 according to the present disclosure will be described with reference to a cross-sectional view taken along an A-A cross section illustrated in FIG. 2. FIG. 3 is a cross-sectional view taken along line A-A of the holding portion of the radio wave control plate casing according to the present disclosure. As illustrated in FIG. 3, the radio wave control plate casing 30 according to the present disclosure accommodates the radio wave control plate 1 by sandwiching the radio wave control plate 1 between the casing member 21 and the casing member 22. For example, in a case in which radio waves are radiated to the radio wave control plate 1 from the right side of FIG. 3, the radio wave may be refracted toward the left side of FIG. 3 up to a maximum refraction angle θ illustrated in FIG. 3. In a case in which the radio wave control plate 1 is of a type that reflects radio waves, the radio waves may be reflected at a maximum reflection angle θ.

In this case, in a case in which a structure constituting the radio wave control plate casing 30 exists within the range of the maximum refraction angle θ or the maximum reflection angle θ, the radio waves strike the structure, and the radio waves cannot be transmitted in the intended direction by the radio wave control plate 1.

Therefore, in the radio wave control plate casing 30 according to the present disclosure, no structure constituting the radio wave control plate casing exists within the maximum angle θ of the radio wave control of the radio wave control plate 1.

Accordingly, by the structure of the radio wave control plate casing 30, hindrance of transmission of radio waves refracted by the radio wave control plate 1 in a desired direction can be suppressed. Even in a case in which the radio wave control plate 1 reflects radio waves, since no structure exists at the maximum reflection angle θ, hindrance of transmission of the reflected radio waves in a desired direction can be suppressed.

### Anchoring Portion

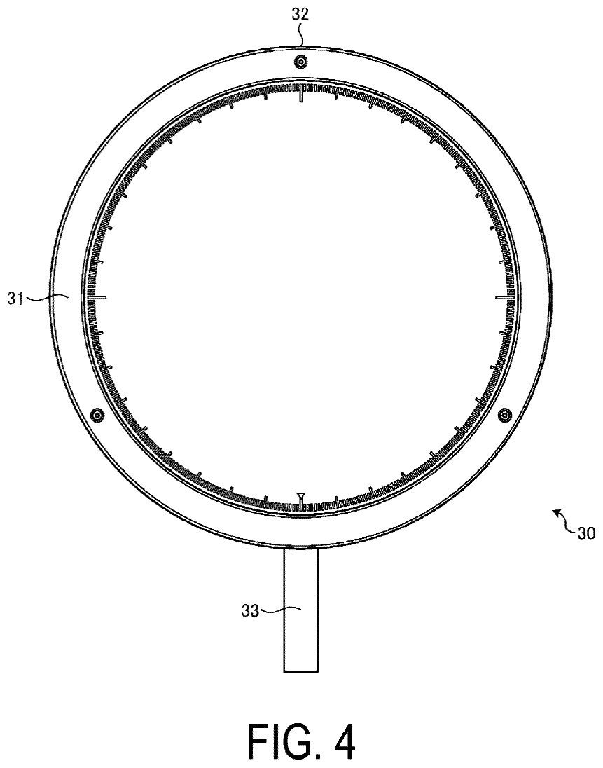

An anchoring portion 33 of the radio wave control plate casing 30 according to the present disclosure will be described with reference to FIG. 4. FIG. 4 is a front view of the anchoring portion of the radio wave control plate casing according to the present disclosure. As illustrated in FIG. 4, the anchoring portion 33 of the radio wave control plate casing 30 according to the present disclosure is provided on a side surface portion of the radio wave control plate casing 30.

That is, the radio wave control plate casing 30 according to the present disclosure further includes the anchoring portion 33 for anchoring and supporting the radio wave control plate casing 30 at the installation place, and the anchoring portion 33 is provided on the side surface portion of the radio wave control plate casing 30.

Thus, hindrance of transmission of the radio waves in a desired direction, which occurs when radio waves refracted by the radio wave control plate 1 strike the anchoring portion 33 of the radio wave control plate casing 30, can be suppressed.

However, when the anchoring portion 33 is provided only on the side surface portion of the radio wave control plate casing 30, a problem exists in that a possibility of failure in securing wind resistance performance at a boundary portion between the casing 30 and the anchoring portion 33 is present.

### Shape of Anchoring Portion

One example of a shape of the anchoring portion 33 that addresses the above-described problem will be described. First, when considering the wind resistance performance, drag is calculated by the following Formula (1). Note that the drag is D, drag coefficient is C_{D}, density of air is ρ, wind speed is U, and wind receiving area is S.

$$\begin{matrix}[ Formula 1 ] & \\ D = {C}_{D} \frac{ρ {U}^{2} S}{2} & ( 1 )\end{matrix}$$

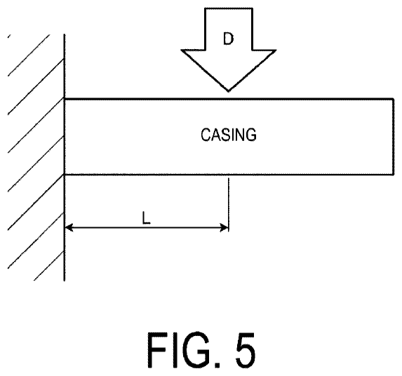

In the radio wave control plate casing according to the present disclosure, the required thickness of the anchoring portion 33 is calculated by using a model illustrated in FIG. 5 from the drag D calculated by Formula (1). FIG. 5 is a diagram illustrating the model of the anchoring portion of the radio wave control plate casing according to the present disclosure. As illustrated in FIG. 5, when the drag D is applied to the radio wave control plate casing 30, a diameter of the anchoring portion 33 is determined so that stress generated in the anchoring portion 33 becomes smaller than allowable stress corresponding to the material of the anchoring portion 33.

Specifically, when allowable stress of the casing 30 is σ, one half of length of the casing 30 is L, and diameter of the anchoring portion 33 is d, the diameter of the anchoring portion 33 is determined so that the following Formula (2) is satisfied.

$$\begin{matrix}[ Formula 2 ] & \\ σ > \frac{32 \times D \times L}{π \times {d}^{3}} & ( 2 )\end{matrix}$$

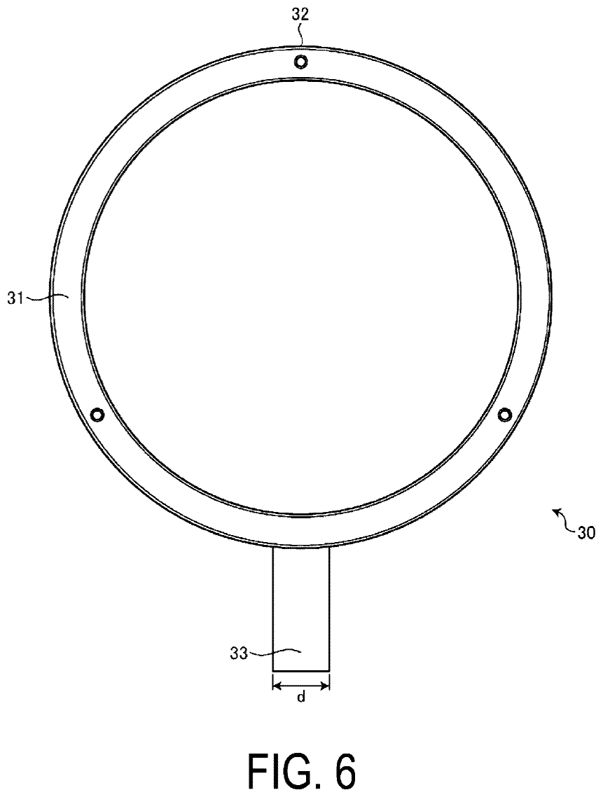

Note that the diameter d of the anchoring portion 33 of the radio wave control plate casing 30 will be described with reference to FIG. 6. FIG. 6 is a diagram illustrating the diameter of the anchoring portion of the radio wave control plate casing according to the present disclosure. As illustrated in FIG. 6, the diameter d of the anchoring portion of the radio wave control plate casing according to the present disclosure is the length of a portion sandwiched by arrows.

Thus, the wind resistance performance of the radio wave control plate casing 30 can be secured. Note that the above model and mathematical formulae are merely examples, and the diameter d of the anchoring portion 33 may be determined by using another model or by using computer simulation according to the structure of the casing or the like.

### Boundary Portion Between Holding Portion and Anchoring Portion

The shape of a boundary portion between the holding portion and the anchoring portion of the radio wave control plate casing according to the present disclosure will be described. As described above, in a case in which the diameter d of the anchoring portion 33 becomes larger than the thickness of the casing 30, stress concentrates on the boundary portion, and thus the thickness of the casing 30 needs to be increased. However, since the weight increases when the thickness of the casing 30 is increased, a wedge shape is provided at the boundary portion between the holding portions 31 and 32 and the anchoring portion 33 of the radio wave control plate casing 30 according to the present disclosure so as to minimize the increase in the weight without causing stress concentration.

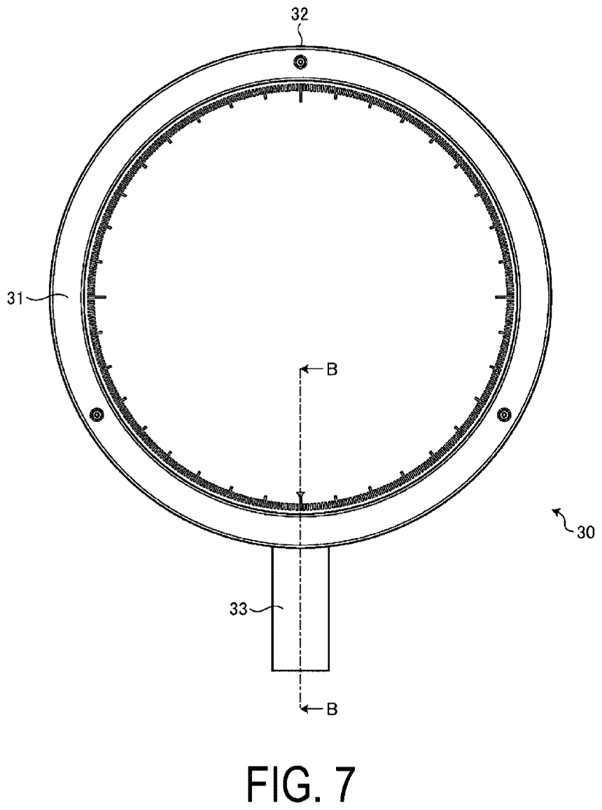

With reference to FIG. 7, a portion where the wedge shape is provided in the radio wave control plate casing 30 according to the present disclosure will be described. FIG. 7 is a diagram illustrating a position of a B-B cross section of the radio wave control plate casing according to the present disclosure. As illustrated in FIG. 7, the wedge shape is formed at a position visible by viewing the B-B cross section vertically.

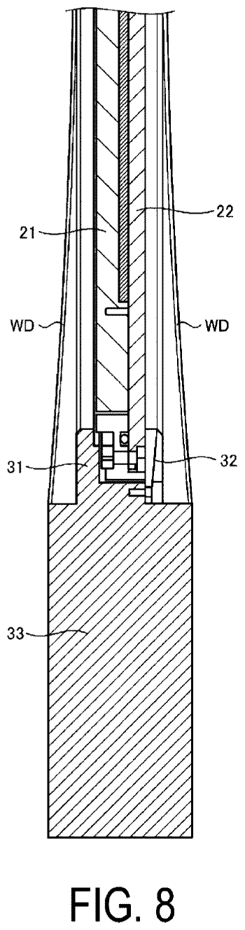

FIG. 8 illustrates a structure visible when the B-B cross section illustrated in FIG. 7 is viewed vertically. FIG. 8 is a cross-sectional view taken along line B-B of the radio wave control plate casing according to the present disclosure. As illustrated in FIG. 8, the radio wave control plate casing 30 according to the present disclosure includes a wedge shape WD formed between the holding portions 31 and 32 and the anchoring portion 33 to relieve the stress concentration. Thus, since the stress concentration can be relieved, strength can be secured.

### Structure of Anchoring Portion

A structure of the anchoring portion 33 of the radio wave control plate casing 30 according to the present disclosure will be described. In consideration of the ease in installing the radio wave control plate casing 30, reduction in weight of the casing 30 is required. In consideration of the wind resistance performance of the radio wave control plate casing 30, the diameter d of the anchoring portion 33 needs to be increased in some cases, and the weight increases when the anchoring portion 33 is increased in thickness. Therefore, in order to reduce the weight while ensuring strength of the anchoring portion 33, cut-out portions are formed in the anchoring portion 33.

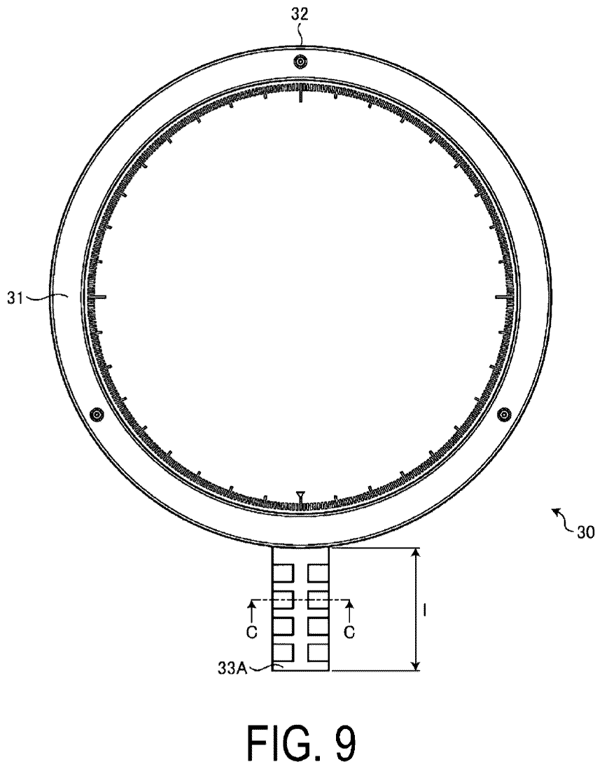

Pattern A of Structure of Anchoring Portion Pattern A of a structure of the anchoring portion of the radio wave control plate casing will be described with reference to FIG. 9. FIG. 9 is a front view of Pattern A of the anchoring portion of the radio wave control plate casing according to the present disclosure. As illustrated in FIG. 9, an anchoring portion 33A of the radio wave control plate casing 30 according to the present disclosure is provided with the cut-out portions so that a plurality of ribs are formed on outer side portions of the anchoring portion 33A. In an example illustrated in FIG. 9, an example in which four cut-out portions are formed is illustrated, but a structure of the anchoring portion 33A illustrated in FIG. 9 is merely an example, and any number of cut-out portions may be formed. A shape of the cut-out portions and a shape of the ribs are not limited to those illustrated in FIG. 9, and any shapes may be employed.

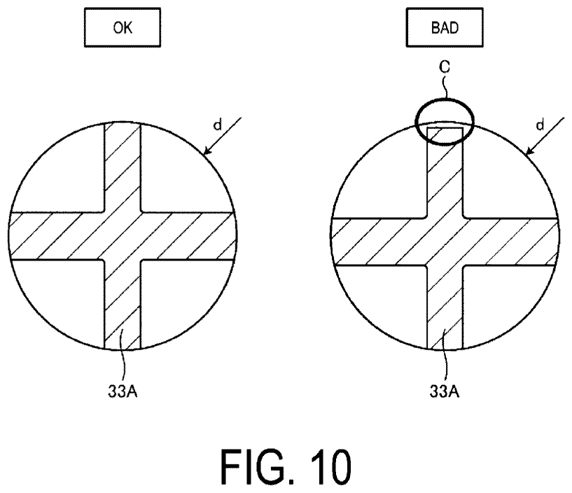

A C-C cross-sectional view of Pattern A of the anchoring portion 33A illustrated in FIG. 9 will be described with reference to FIG. 10. FIG. 10 is a cross-sectional view taken along line C-C of Pattern A of the anchoring portion of the radio wave control plate casing according to the present disclosure. As illustrated in a portion surrounded by an ellipse C in a right-side view of FIG. 10, a structure is not a structure in which the tips of the ribs formed by the cut-out portions are positioned inside a circumference of the diameter d, as illustrated in a left-side view of FIG. 10, the structure is preferably a structure in which none of the tips of the ribs are positioned inside a circle of the diameter d. Note that, in FIG. 10, a hatched portion indicates the anchoring portion 33A, and blank portions indicate the cut-out portions.

Accordingly, the weight of the anchoring portion 33A can be reduced while strength is secured.

### Pattern B of Structure of Anchoring Portion

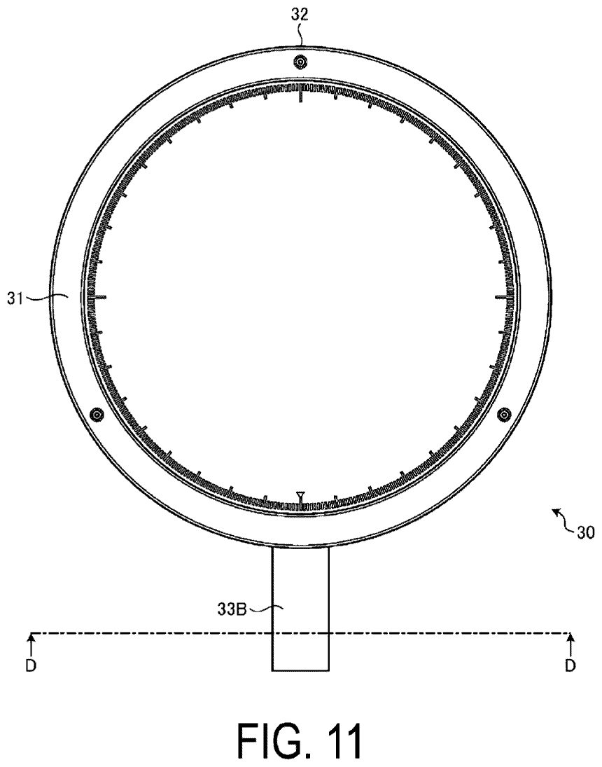

Pattern B of a structure of the anchoring portion of the radio wave control plate casing will be described with reference to FIG. 11. FIG. 11 is a front view of Pattern B of the anchoring portion of the radio wave control plate casing according to the present disclosure. As illustrated in FIG. 11, Pattern B of an anchoring portion 33B of the radio wave control plate casing 30 according to the present disclosure has no cut-out portions on outer side portions of the anchoring portion 33B, that is, no ribs are formed.

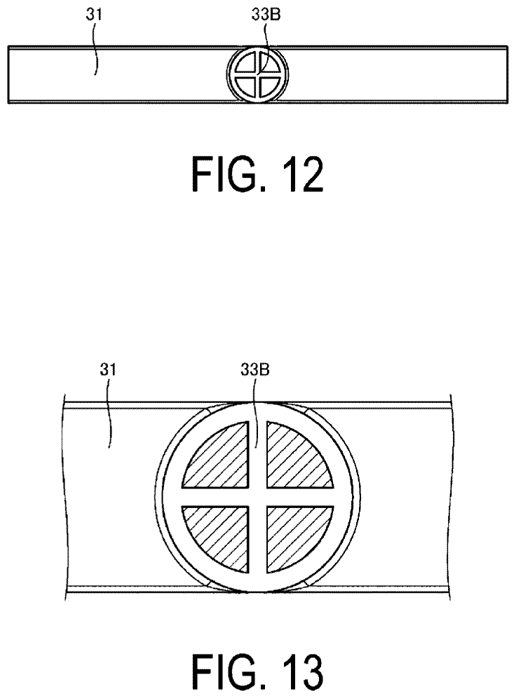

A cross-sectional view taken along line D-D of Pattern B of the anchoring portion 33B illustrated in FIG. 11 will be described with reference to FIG. 12. FIG. 12 is a cross-sectional view taken along line D-D of Pattern B of the anchoring portion of the radio wave control plate casing according to the present disclosure. As illustrated in FIG. 12, the anchoring portion 33B of the radio wave control plate casing 30 is provided with cut-out portions so that a plurality of ribs are formed inside the anchoring portion 33B. In the example illustrated in FIG. 12, an example in which the four ribs are formed is illustrated, but the structure of the anchoring portion 33B illustrated in FIG. 12 is merely an example, and any number of ribs may be formed.

The structure of Pattern B of the anchoring portion 33B will be described with reference to the enlarged view of the anchoring portion 33B in FIG. 12. FIG. 13 is a detailed view of a cross-sectional view taken along line D-D of Pattern B of the anchoring portion of the radio wave control plate casing according to the present disclosure. As illustrated in FIG. 13, in Pattern B of the anchoring portion 33B, hatched portions are the cut-out portions. Note that the structure of Pattern B of the anchoring portion 33B illustrated in FIG. 13 is an example, and the internal structure of the anchoring portion 33B may be formed in any manner. Accordingly, the weight of the anchoring portion 33B can be reduced while strength is secured.

### Configuration and Effect

The radio wave control plate casing 30 according to the present disclosure is the radio wave control plate casing 30 that accommodates the radio wave control plate 1 for reflecting or refracting radio waves, and the radio wave control plate casing 30 includes no structure constituting the radio wave control plate casing 30 within a maximum angle θ for radio wave traveling direction control of the radio wave control plate 1.

According to this configuration, by the structure of the radio wave control plate casing 30, hindrance of transmission of the radio waves controlled by the radio wave control plate 1 in a desired direction can be suppressed. Thus, the radio wave control plate casing 30 that has less influence on the reflected waves or the refracted waves of the radio wave control plate can be provided.

The radio wave control plate casing 30 according to the present disclosure further includes the anchoring portion 33 anchoring and supporting the radio wave control plate casing 30 at an installation place, and the anchoring portion 33 is provided on a side surface portion of the radio wave control plate casing 30.

According to this configuration, by the anchoring portion 33 of the radio wave control plate casing 30, hindrance of transmission of the radio waves controlled by the radio wave control plate 1 in a desired direction can be suppressed. Thus, the radio wave control plate casing 30 that has less influence on the reflected waves or the refracted waves of the radio wave control plate 1 can be provided.

The radio wave control plate casing 30 according to the present disclosure further includes the holding portion that holds the radio wave control plate 1, and the wedge shape that relieves the stress concentration is formed between the holding portion and the anchoring portion.

According to this configuration, the stress concentration between the holding portion and the anchoring portion of the radio wave control plate casing 30 can be relieved, thus sufficient strength can be secured. Therefore, the radio wave control plate casing 30 that has less influence on the reflected waves or the refracted waves of the radio wave control plate can be provided while sufficient strength is secured.

The anchoring portion 33 of the radio wave control plate casing 30 according to the present disclosure is provided with the cut-out portions so that the plurality of ribs are formed on the outer side of the anchoring portion 33.

According to this configuration, both securing the wind resistance performance of the radio wave control plate casing 30 and reducing the weight can be achieved. Thus, the radio wave control plate casing 30 that has less influence on the reflected waves or the refracted waves of the radio wave control plate can be provided while achieving both securing the wind resistance performance and reducing the weight.

The anchoring portion 33 of the radio wave control plate casing 30 according to the present disclosure is provided with cut-out portions so that a plurality of ribs are formed inside the anchoring portion 33.

According to this configuration, both securing the wind resistance performance of the radio wave control plate casing 30 and reducing the weight can be achieved. Thus, the radio wave control plate casing 30 that has less influence on the reflected waves or the refracted waves of the radio wave control plate can be provided while achieving both securing the wind resistance performance and reducing the weight.

The diameter of the anchoring portion 33 of the radio wave control plate casing 30 according to the present disclosure is determined so that, when drag is D, drag coefficient is C_{D}, density of air is ρ, wind speed is U, and wind receiving area is S, the drag D is calculated based on the following Formula (1), and when allowable stress of the casing 30 is σ, one half of the length of the casing 30 is L, and the diameter of the anchoring portion 33 is d, the value on a right-hand side of the following Formula (2) is smaller than the value on a left-hand side.

$$\begin{matrix}[ Formula 1 ] & \\ D = {C}_{D} \frac{ρ {U}^{2} S}{2} & ( 1 )\end{matrix}$$

$$\begin{matrix}[ Formula 2 ] & \\ σ > \frac{32 \times D \times L}{π \times {d}^{3}} & ( 2 )\end{matrix}$$

According to this configuration, the wind resistance performance of the radio wave control plate casing 30 can be secured. Therefore, the radio wave control plate casing 30 that has less influence on the reflected waves or the refracted waves of the radio wave control plate can be provided while the wind resistance performance is secured.

Although embodiments of the present disclosure have been described above, the embodiments are not limited to the contents of the embodiments. Constituent elements described above include those that can be easily assumed by a person skilled in the art, those that are substantially identical to the constituent elements, and those within a so-called range of equivalency. The constituent elements described above can be combined as appropriate. Various omissions, substitutions, or modifications of the constituent elements can be made without departing from the spirit of the above-described embodiments.

### INDUSTRIAL APPLICABILITY

A radio wave control plate casing according to the present embodiment can be used, for example, for the radio wave control plate casing that has less influence on reflected waves or refracted waves of the radio wave control plate.

### REFERENCE SIGNS

100 Radio wave reflection apparatus
1 Radio wave control plate
10 Casing
20 Casing
21 Casing member
22 Casing member
30 Casing
31 Casing member (holding portion)
32 Casing member (holding portion)
33 Anchoring portion
4 Metal plate
5 Metal plate
6 Metal plate
7 Metal plate
8 Metal plate
9 Packing

1. A radio wave control plate casing configured to accommodate a radio wave control plate configured to reflect or refract radio waves,
the radio wave control plate casing being configured to comprise no structure constituting the radio wave control plate casing within a maximum angle θ for radio wave traveling direction control of the radio wave control plate.

2. The radio wave control plate casing according to claim 1, further comprising:
an anchoring portion configured to anchor and support the radio wave control plate casing at an installation place,
wherein the anchoring portion is provided on a side surface portion of the radio wave control plate casing.

3. The radio wave control plate casing according to claim 2, further comprising:
a holding portion configured to hold the radio wave control plate,
wherein a wedge shape is formed between the holding portion and the anchoring portion.

4. The radio wave control plate casing according to claim 2,
wherein the anchoring portion is provided with cut-out portions, with a plurality of ribs being formed on an outer side of the anchoring portion.

5. The radio wave control plate casing according to claim 2,
wherein the anchoring portion is provided with cut-out portions, with a plurality of ribs being formed inside the anchoring portion.

6. The radio wave control plate casing according to claim 2,
wherein a diameter of the anchoring portion is determined so that, when drag is D, drag coefficient is C_{D}, density of air is ρ, wind speed is U, and wind receiving area is S, the drag D is calculated based on Formula (1) below, and when allowable stress of the casing is σ, one half of a length of the casing is L, and the diameter of the anchoring portion is d, a value on a right-hand side of Formula (2) below is smaller than a value on a left-hand side.
$$\begin{matrix}[ Formula 1 ] & \\ D = {C}_{D} \frac{ρ {U}^{2} S}{2} & ( 1 )\end{matrix}$$
$$\begin{matrix}[ Formula 2 ] & \\ σ > \frac{32 \times D \times L}{π \times {d}^{3}} & ( 2 )\end{matrix}$$
